(19) United States
(12) Patent Application Publication
(10) Pub. No.: US 2010/0100860 A1
(43) Pub. Date: Apr. 22, 2010

(54) METHOD AND APPARATUS FOR DEBUGGING AN ELECTRONIC SYSTEM DESIGN (ESD) PROTOTYPE

(76) Inventors: Chioumin M. Chang, San Jose, CA (US); Thomas B. Huang, San Jose, CA (US); Huan-Chih Tsai, San Jose, CA (US)

Correspondence Address: Haynes and Boone, LLP;IP Section, 2323 Victory Avenue, SUITE 700, Dallas, TX, 75219, US

(21) Appl. No.: 12/255,606

(22) Filed: Oct. 21, 2008

(51) Int. Cl. G06F 17/50

(52) U.S. Cl. 716/5

(57) ABSTRACT

Using a vector-based emulation technique, a hardware-based prototyping system reduces time-consuming recompilation and reduces the iteration time for a verification run. The vector-based emulation technique takes advantage of information derived from user-defined probe points, automatically generated probe points and low-latency snapshots. Using a bounded-cycle simulation technique, the hardware-based prototyping system can provide complete or partial simulation traces covering interested signals and can efficiently evaluates assertions. A user is therefore able to debug in a real system test and to identify causes of fault conditions interactively under a controlled vector debugging environment.

### CROSS-REFERENCE TO RELATED APPLICATIONS

The present application relates to the following U.S. patent applications (“Copending Applications”): (a) U.S. non-provisional patent application, entitled “Method of Progressively Prototyping and Validating a Customer's Electronic System Design,” Ser. No. 11/953,366, filed on Dec. 10, 2007, and (b) U.S. non-provisional patent application, entitled “Integrated Prototyping System For Validating An Electronic System Design,” Ser. No. 12/110,233, filed on Apr. 25, 2008. The disclosures of the Copending Applications are hereby incorporated by reference in their entireties.

### BACKGROUND OF THE INVENTON

1. Field of the Invention

The present invention relates to electronic system design (ESD) automation. In particular, the present invention relates to automated tools for efficiently debugging an ESD prototype.

2. Discussion of the Related Art

In a design process for an electronic circuit, the design is typically verified and validated prior to manufacturing. A design is verified when the design is shown to be functionally correct in a simulation environment. A design is validated when the design is shown in an implementation (e.g., in a prototype) to be functionally correct in an application environment. FIG. 1 shows conventional system test and debugging environment 100 which includes simulation subsystem 110 and prototyping subsystem 120, in which a design is verified and validated. As shown in FIG. 1, design 130 is first verified at simulator 112, which is driven by stimuli provided by test bench 113. The simulated design's responses to the stimuli are captured at step 114 and checked against the expected responses at step 115. The responses from simulator 112 are captured, for example, in a database or data storage system. Such responses include, at each system clock cycle, system output values of the design and the values of the specified signals and included monitors. The captured responses and the expected responses are compared. If the captured responses match the expected response, the design is passed to validation process 120. Otherwise, the designer performs debugging (i.e., examining the design to uncover the reason for the discrepancies between the responses from the simulated design and the expected responses). Debugging may involve, at step 116, modifying the design or design parameters in simulator 112 and running more simulations under the modified conditions of the design or design parameters. Check points may be specified in the design to isolate the fault states. At each check point, internal nodes are examined in order to isolate the cause of each fault state. After a fault state is diagnosed and corrected, tests are created to ascertain that the problem of each fault state is rectified. In addition, regression tests are also ran to ensure that fixing the fault states do not lead to other errors as unintended consequences. When both the cause of the discrepancies in the responses and the necessary corrections are identified, design 130 is formally modified at step 117 by an “engineering change order.” Eventually, design 130 is verified and passed to validation process 120.

Design 130 is validated by compiling the design onto prototyping platform 122, which is driven by stimuli provided by peripherals 123. Prototyping platform 122 may be, for example, a circuit emulator based on field-programmable gate arrays (FPGAs). The peripherals are typically devices that are expected to communicate with the device to be emulated or prototyped (i.e., the device under verification or “DUV”) in the target system. The prototyped design's responses to the stimuli are captured at step 124 and checked against the expected responses at step 125. In validation, an expected response may be expressed as an “assertion.” If the captured responses match the expected response, the design is validated. Otherwise, the designer performs debugging. Debugging may involve, at step 126, modifying the design or design parameters, recompiling the design onto prototyping platform 122, and running more application test under the modified conditions of the design or design parameters. As shown in FIG. 1, at step 127, the user may specify nodes in design 130 to be observed or probed. Design 130 is then re-compiled with signal paths over which the electrical signals at the specified nodes are brought out or otherwise made available for examination during debugging. When both the cause of the discrepancies in the responses and the necessary corrections are identified, design 130 is formally corrected at step 117 by an “engineering change order.” After correction, design 130 is verified and validated again before being accepted into manufacturing. There may be several cycles of verification and validation.

Simulator 112 may include a conventional software-based simulator (e.g., an event-driven simulator), and prototyping platform 122 may include a conventional hardware-based prototyping system (e.g., an FPGA-based emulation system). In a simulation or co-emulation environment, the conventional software-based simulator is referred to as a “simulator controlled environment.” The conventional hardware-based prototyping system is referred to as a “system prototype environment.”

One disadvantage of a simulator controlled environment is its low throughput, which limits such an approach to being suitable only for block level tests and top level integrity tests. System level regression tests are often bypassed because of the significant time and effort that must be invested until much later in the design process. However, as system level regression tests are required to qualify a design, running system level regression tests at a later time may result in more difficult debugging tasks at the end of the project and undesirable schedule slippage.

In a system prototype environment, it is desired to use the prototyping system to perform compatibility tests to verify the DUV's operations with real peripherals and instruments, using device drivers under actual or close to actual operational conditions. However, emulators being used in prototyping systems are often too slow for many kinds of compatibility tests.

Prototyping systems are also used to monitor system behavior under application software controls. For such an application, the checkers (e.g., checker at step 125) typically reside in the peripherals, the instruments and the device drivers. Check points and probes used to flag fault states are usually compiled with the design of DUV into the prototyping system. A logic analyzer is used to probe internal and external signals¹. However, because access to internal signals is limited to the compiled probe points, isolating the cause of a fault state often requires multiple recompilations. Therefore, it is difficult to use such a prototyping system to isolate the cause of fault states. Further, because each iteration involves a recompilation and a verification run, such a prototyping system is very time-consuming. ¹Internal signals to be probed are typically brought out to input/output pins by diagnostic logic circuits or monitors compiled with the DUV.

### SUMMARY

According to one embodiment of the present invention, a hardware-based prototyping system reduces time-consuming recompilation and reduces the iteration time for a verification run using a vector-based emulation technique. The vector-based emulation technique takes advantage of information derived from user-defined probe points, automatically generated probe points and low-latency snapshots. The present invention can provide complete or partial simulation traces covering interested signals and can efficiently evaluates assertions. Using a bounded-cycle simulation technique, the hardware-based prototyping system of the present invention enables a user to debug in a real system test and to identify causes of fault conditions interactively under a controlled vector debugging environment.

The present invention therefore avoids the low-throughput disadvantage of a conventional simulator and the long iteration times of a conventional hardware-based prototyping system.

The present invention is better understood upon consideration of the detailed description below and the accompanying drawings.

### BRIEF DESCRIPTION OF THE DRAWINGS

FIG. 1 represents a high level view of system test and debugging environment 100, which is used for debugging a system prototype.

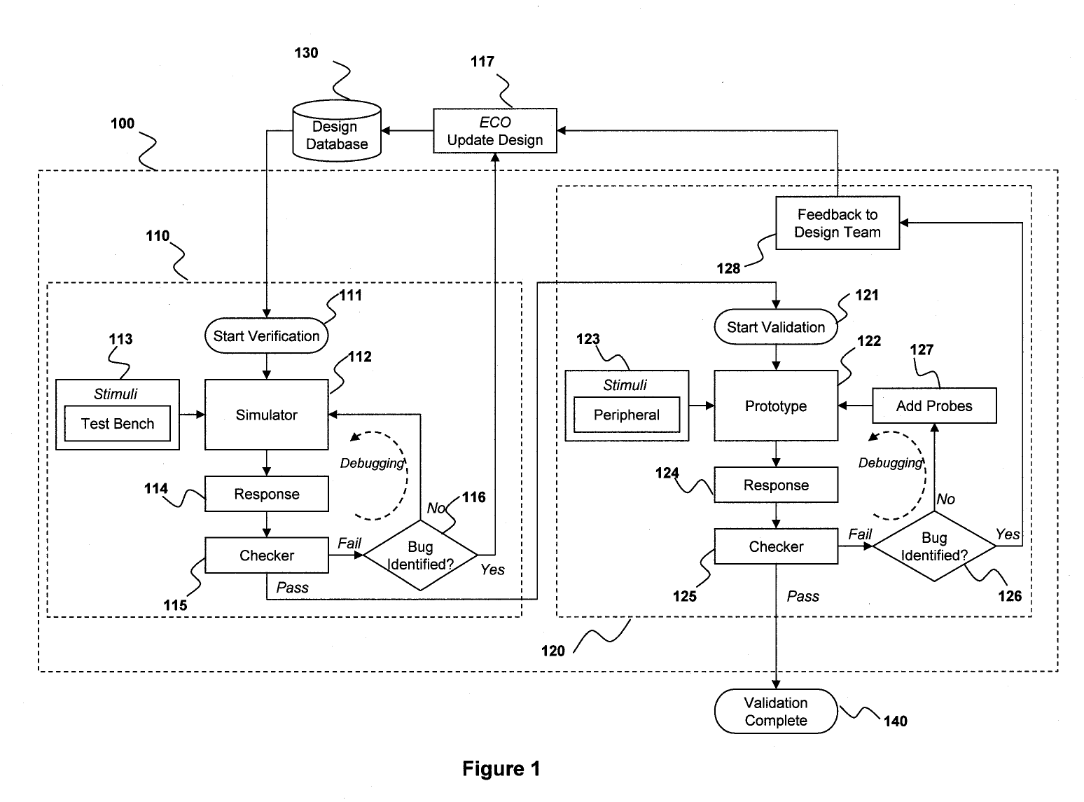

FIG. 2(a) is a block diagram of integrated prototyping platform 200, in accordance with one embodiment of the present invention.

FIG. 2(b) is a flow chart showing an overall prototype debugging flow used in integrated prototyping platform 200, in accordance with one embodiment of the present invention.

FIG. 3 illustrates, in one example, using a reference clock to replace two input/output clock signals during vector emulation.

FIG. 4 is a flow chart showing the steps carried out in a probe-based vector emulation, according to one embodiment of the present invention.

FIG. 5 is a flow chart showing the steps carried out in a snapshot-based vector emulation, according to one embodiment of the present invention.

FIG. 6 is a flow chart showing the steps in a hybrid vector emulation, according to one embodiment of the present invention.

FIG. 7 is a flow chart showing the process of identifying probe points automatically, according to one embodiment of the present invention.

FIG. 8 is a flow chart showing the process of identifying state elements for a snapshot automatically, according to one embodiment of the present invention.

FIGS. 9(a)-9(c) illustrate removing sequential loops in a sequential graph, in accordance with the present invention.

FIG. 10 shows the fan-in cone of signal n, with signal S1 replaced by a probe point.

FIG. 11 shows that values of signal S1 at times t-2, t-1 and t allow the value of signal n at time t be derived.

### DETAILED DESCRIPTION OF THE PREFERRED EMBODIMENTS

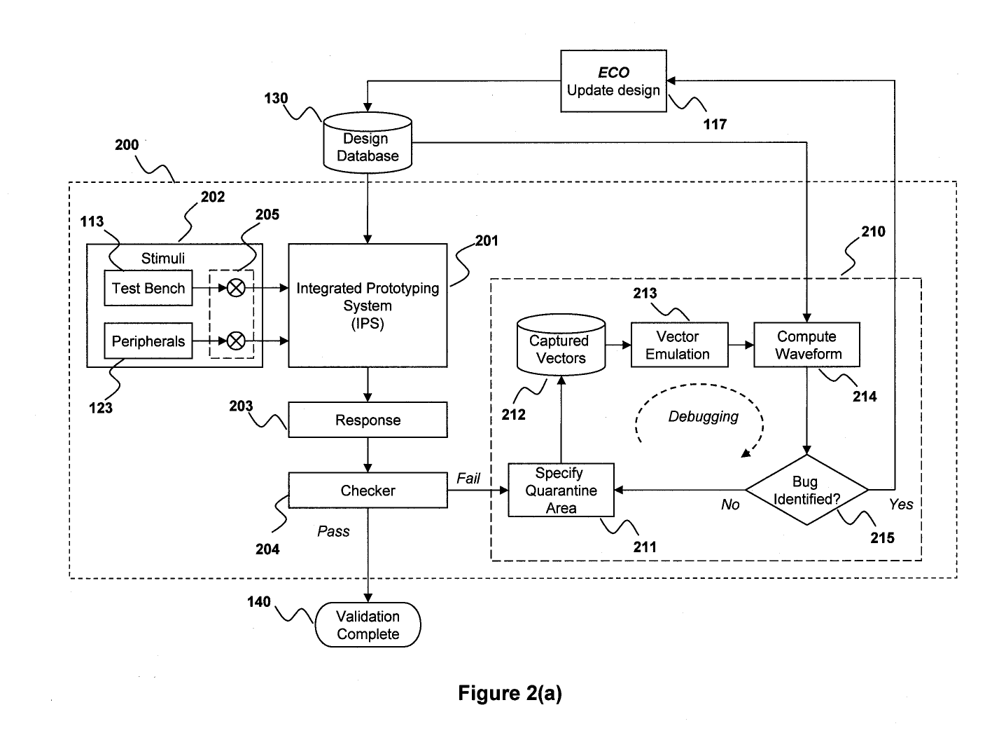

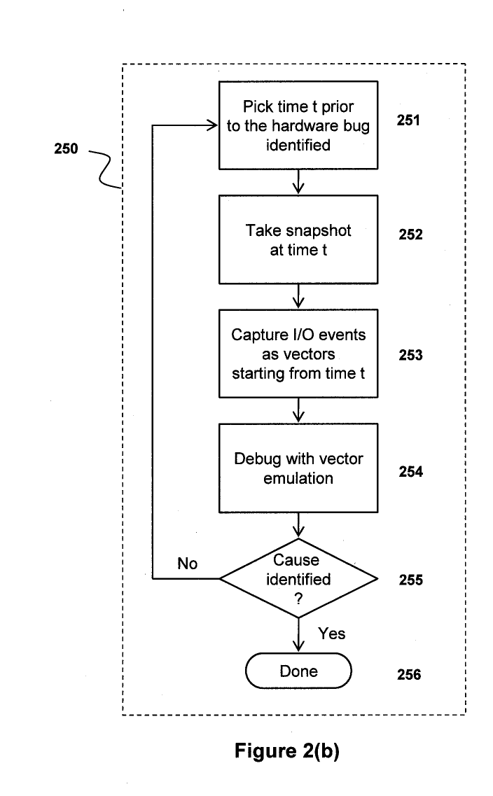

The present invention provides an integrated prototyping system which includes a controlled vector debugging environment. FIG. 2(a) is a block diagram of integrated prototyping platform 200, in accordance with one embodiment of the present invention. As shown in FIG. 2(a), a design in design database 130 is verified and validated in integrated prototyping system 201, which integrates both a simulator system and a prototyping system. IPS 201 may be implemented using the prototyping systems described in the Copending Applications, which are incorporated by reference above. Stimuli may be provided to IPS 201 by test bench 113 and peripherals 123. In IPS 201, the design may have different portions that are at different stages of development. For example, one portion of the design may be in the process of being verified, while another portion, more advanced in development, may be in the process of being validated. Therefore, test bench 113 may provide stimuli into a simulator in IPS 201 for the portions of the design being verified, while peripherals 123 may provide signals for use in the portions of the design being validated. The responses of IPS 201 in response to stimuli are captured at step 203 and checked at step 204. If all portions of the design are validated, the design may pass to manufacturing (step 140). Otherwise, as shown in FIG. 2(a), an iterative debugging process 210 is provided.

In debugging process 210, a designer first specifies a portion of the design (“quarantine area”, labeled in FIG. 2(a) by reference numeral 211) that the designer suspects to include one or more design or implementation errors (the “bug” or “bugs”). A snapshot of the state variables of the quarantine area at a specified time point, and the input stimuli and output responses for the quarantine area for each clock period are captured and stored in captured vector database (step 212) for subsequent retrieval as vectors. These vectors are used in at vector emulation step 213 (explained in further details below). During debugging process 210, the waveforms of some internal nodes of the quarantined area which are not specifically probed in the prototyping system are constructed by IPS 201 at step 214 to assist in debugging. Debugging process 210 is reiterated until the bug or bugs are identified (step 215). When the necessary modifications to the design are identified, the design is modified by an ECO at step 117. Verification and validation resumes are then resumed.

FIG. 2(b) is a flow chart showing an overall prototype debugging flow 250 in IPS 200, in accordance with one embodiment of the present invention. Debugging begins when a fault condition is detected during a system test. As showing in FIG. 2(a), when a fault condition is detected, a user of a prototyping system of the present invention selects a time point that is prior to the detection of the fault condition (step 251). At step 252, a snapshot of all state variables (i.e., contents of flip-flops, registers and memory locations) is captured at the selected previous time point. From the selected previous time point, the emulation in the prototyping system is executed towards the time point at which the fault condition is detected. The duration of the emulation may be a specified number of clock cycles (e.g., advance the emulation back to the time point of fault detection), or may be limited by the memory available for storing the data values of the system state elements. During the period of emulation, all input and output events are captured as vectors relative their respective clock signals (step 253). Then, at step 254, vector emulation is then used for debugging using the captured vectors. As described below, one embodiment of the present invention, vector emulation may be carried out using “probe-based vector emulation,” “snapshot based vector emulation,” or “hybrid vector emulation.” As explained below, during vector emulation, the signal values at user-defined probe points and automatically generated probe points, and the state values of low-latency snapshots are captured. These captured values are then used to in bounded-cycle simulations (explained in further detail below). If the cause of the fault state is isolated during vector emulation, the process is complete (step 256). Otherwise, the process returns to step 251, where an even earlier time point is selected, and steps 251-255 is repeated.

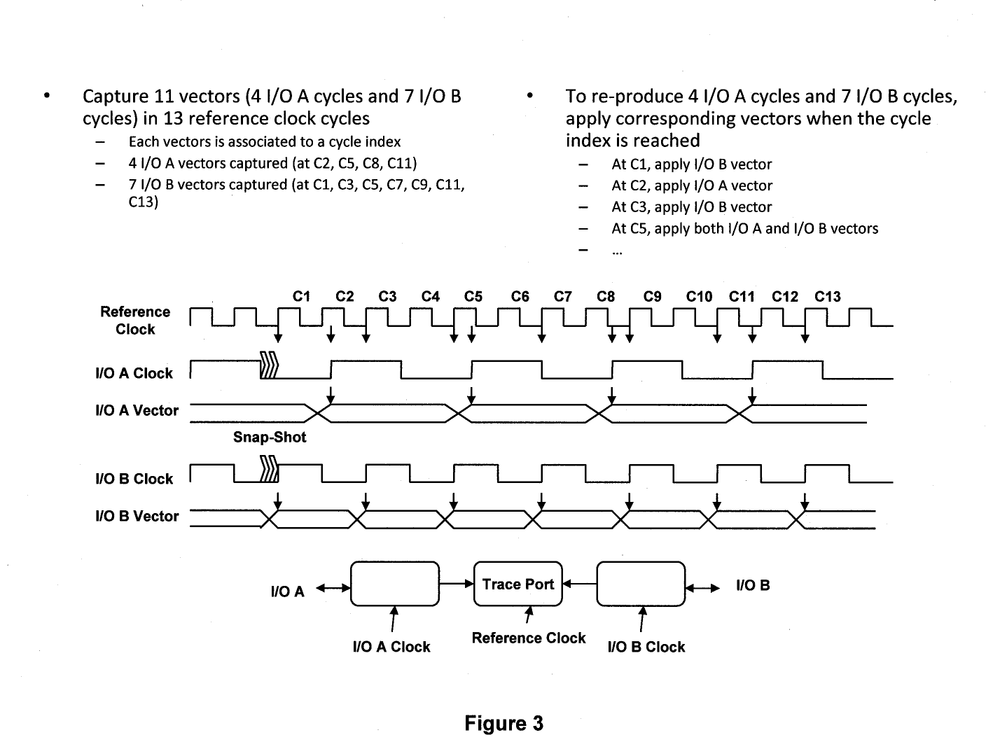

During vector emulation in step 254, a single reference clock is used in the prototyping system in place of the various system clocks. Clock switches are embedded in the DUV and configured into the prototype FPGAs to allow the reference clock to be used. FIG. 3 illustrates, in one example, using a reference clock to replace two input/output (I/O) clock signals during vector emulation. As shown in FIG. 3, a DUV includes I/O clock signals A and B which are associated with I/O events of the DUV. At time t, the complete state snapshot is captured. Over 13 clock cycles of the reference signal (labeled individually clock cycles C1, C2, . . . , C13), I/O Clock A has four clock cycles (labeled individually clock cycles A1,A2, A3 and A4) and I/O clock B has 7 clock cycles (labeled B1, B2, . . . , B7). For vector emulation, the clock cycles of individual I/O clocks A and B are mapped into the clock cycles of the reference clock. As shown in FIG. 3, I/O clock cycles A1, A2, A3 and A4 are mapped to reference clock cycles C2, C5, C8 and C11, respectively. Similarly, I/O clock cycles B1, . . . , B7 are mapped to reference clock cycles C1, C3, C5, C7, C9, C11 and C13, respectively. During vector emulation, the captured vectors are applied to the prototype at the respective mapped cycle of the reference clock (e.g., the vector corresponding to cycle B4 is applied at cycle C7 of the reference clock).

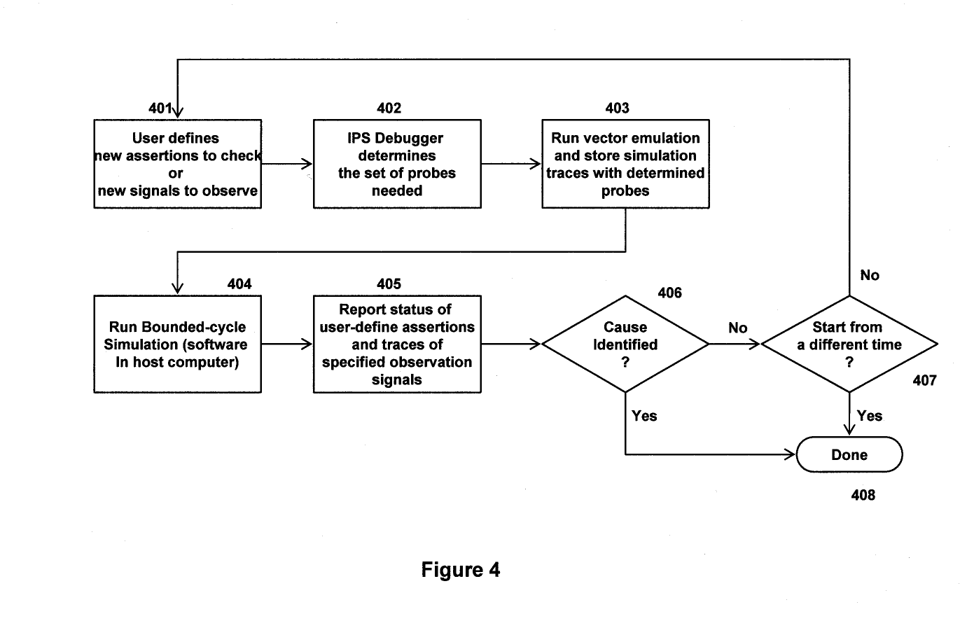

FIG. 4 is a flow chart showing the steps carried out in a probe-based vector emulation, according to one embodiment of the present invention. As shown in FIG. 4, in each iteration of a probe-based vector emulation, the user specifies new points at which signal values are to be observed and new assertions to check (step 401). At step 402, the prototyping system then generates the set of required probe points, including selected ones of the user-specified probe points and the automatically generated probe points (explained below). The required user-specified probe points and the system-generated probe points are then configured into the prototyping system. Emulation is then carried out in the prototyping system using the reference clock for the required number of cycles using the previously captured I/O vectors (step 403); during the emulation, the signal values at the user-specified probe points and the system-generated probe points are recorded for each reference clock cycle. A bounded-cycle simulation is carried out in the host computer using the recorded signal values (step 404) to derive values of interested signals. The evaluated user-specified assertions and the signal values of the selected user-specified probe or observation points are then output for the user's review (step 405). If the user's examination of these output values (at step 406) yields the cause of the fault condition, debugging is deemed complete (step 408). Otherwise, at step 407, the user determines if a different beginning time for vector emulation is required. If so, a new vector emulation is required. In that case, steps 251-256 are repeated. Otherwise, steps 401 to 407 are reiterated.

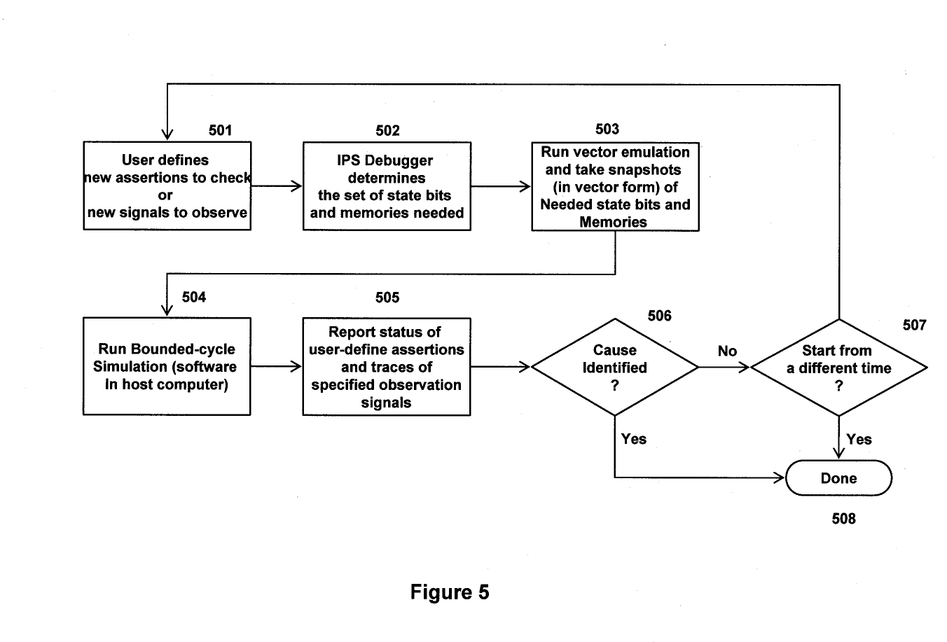

FIG. 5 is a flow chart showing the steps carried out in a snapshot-based vector emulation, according to one embodiment of the present invention. As shown in FIG. 5, in each iteration of a snapshot-based vector emulation, the user specifies new probe or observation points for signal values to observe and new assertions to check (step 501). At step 502, the prototyping system then generates a set of required user-specified probe points and a set of required low-latency snapshots (explained below). The selected user-specified probe points and snapshot controls are then configured into the prototyping system. Emulation is then carried out in the prototyping system using the reference clock for the required number of cycles using the previously captured I/O vectors (step 503); during the emulation, the signal values at the probes are recorded for each reference clock cycle, together with the values of the state variables specified in the low-latency snapshots. A bounded-cycle simulation is carried out in the host computer using the recorded signal values and the low-latency snapshots (step 504) to derive values of interested signals. The evaluated user-specified assertions and the signal values of the selected user-specified observation points are then output for the user's review (step 505). If the user's examination of these output values (at step 506) yields the cause of the fault condition, debugging is deemed complete (step 508). Otherwise, at step 507, the user determines if a different beginning time for vector emulation is required. If so, a different vector emulation is required. In that case, steps 251-256 are repeated. Otherwise, steps 501 to 507 are reiterated.

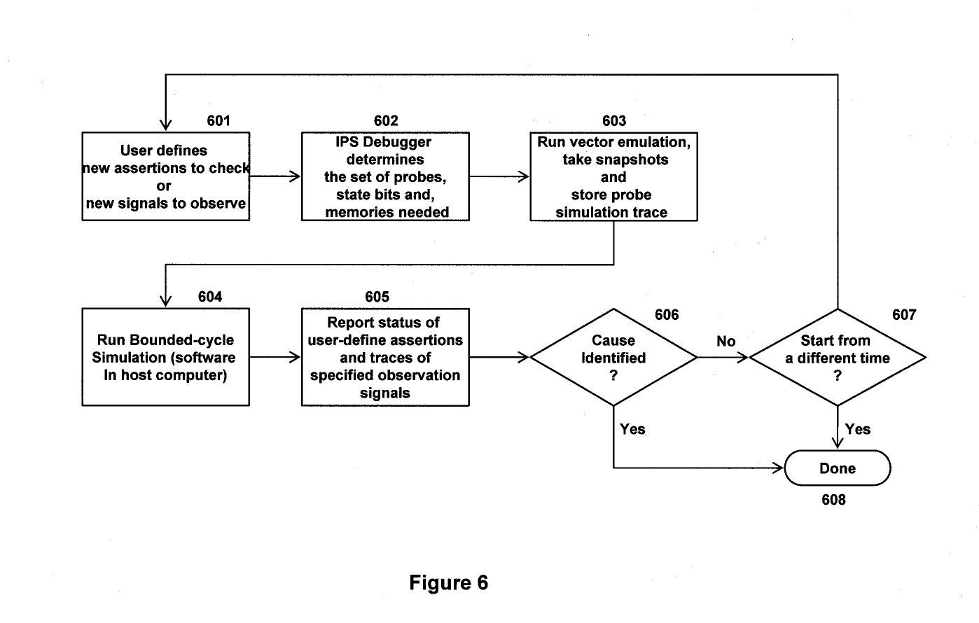

FIG. 6 is a flow chart showing the steps in a hybrid vector emulation, according to one embodiment of the present invention. As shown in FIG. 6, in each iteration of a hybrid vector emulation, the user specifies new observation or probe points for signal values to be observed and new assertions to check (step 601). At step 602, the prototyping system then generates a set of required probe points from both user-specified probe points and automatically generated probe points (explained below) and a set of required low-latency snapshots (explained below). The required control for the probe points and the snapshots are then configured into the prototyping system. Emulation is then carried out in the prototyping system using the reference clock for the required number of cycles using the previously captured I/O vectors (step 603); during the emulation, the signal values at the required probe points are recorded for each reference clock cycle, together with the values of the state variables specified in the low-latency snapshots. A bounded-cycle simulation is carried out in the host computer using the recorded signal values and the low-latency snapshots (step 604) to derive values of interested signals. The evaluated user-specified assertions and the signal values of the selected user-specified observation points are then output for the user's review (step 605). If the user's examination of these output values (at step 606) yields the cause of the fault condition, debugging is deemed complete (step 608). Otherwise, at step 607, the user determines if a different beginning time for vector emulation is required. If so, a different vector emulation is required. In that case, steps 251-256 are repeated. Otherwise, steps 601 to 607 are reiterated.

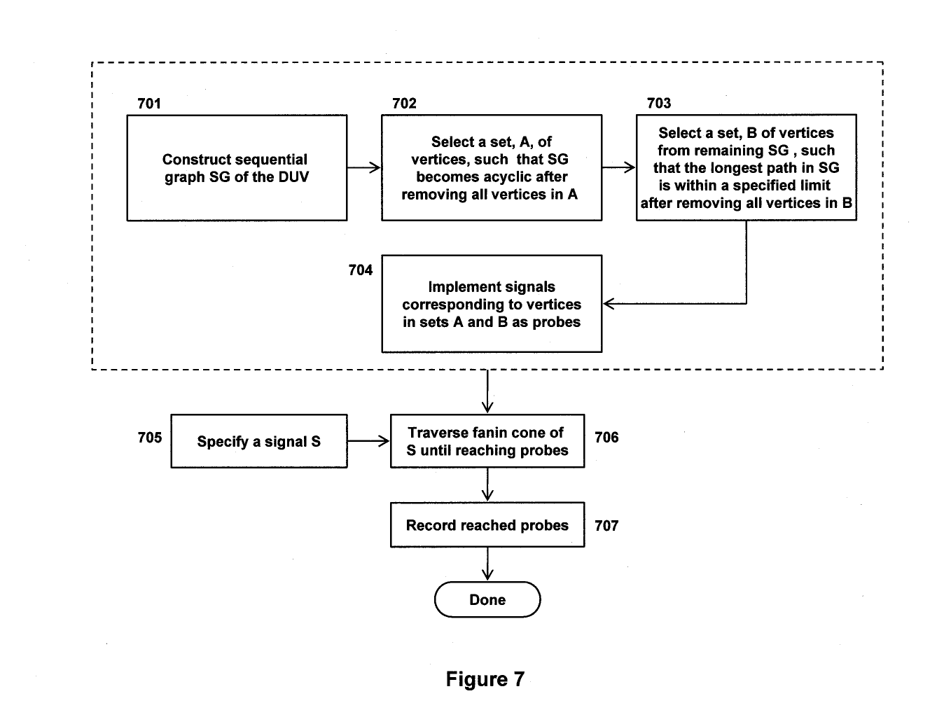

According to one embodiment of the present invention, probe points are automatically generated and configured in the DUV that is compiled into the prototype. These automatically generated probe points facilitate debugging and avoid recompilation when some other observation points are subsequently requested by the user. FIG. 7 is a flow chart showing the process of identifying probe points automatically, according to one embodiment of the present invention. As shown in FIG. 7, at step 701, sequential graph SG of the DUV is constructed. In this context, a sequential graph is an abstract representation of a logic circuit in which all sequential or state elements are represented by vertices of the sequential graph, and all combinational circuit paths of signals flowing from one vertex to another vertex are represented by a directed edge. In general, a sequential graph is a cyclic directed graph (i.e., including loops, referred to as “sequential loops”) because of feedback paths. A sequential graph without a loop (e.g., a sequential graph with sequential loops removed) is an acyclic directed graph. At step 702, set A consisting of vertices of sequential graph SG is identified. The vertices of set A are vertices whose removal from sequential graph SG would result in an acyclic graph (i.e., acyclic graph ASG). At step 703, set B of vertices of acyclic graph ASG is identified. The vertices of set B are the vertices whose removal results in an acyclic graph having a depth for its longest path less than a specified number. The depth of a path in an acyclic directed graph is the number of the vertices in the path. Step 704 then implements probe points for the signals at the vertices of sets A and B. Steps 701-704 may be performed “off-line” (i.e., generated at the time the design is compiled, rather than at time of each debugging session). At the time of debugging, when a user specifies signal S of the design to be observed (step 705), the fan-in cone of signal S is traversed on the sequential graph SG, terminating at probe points (step 706). These probe points are the required probes to be automatically generated (step 707) for a subsequent bounded-cycle simulation.

In a conventional debugging system, since each snapshot saves the values of all state elements, the frequency at which snapshots can be taken is limited in practice by the time required to retrieve the saved snapshot values. As a result, snapshots are typically taken every few seconds. Therefore, while the faulty states can be captured, the cause states are typically missed. The iterations required to home into the cause states significantly reduce the throughput of this approach. According to one embodiment of the present invention, however, a low-latency snapshot saves only required state elements and memory contents (i.e., the state elements and memory contents determined to be required for deriving the values of signals giving rise to a fault state) and saves their values according to a random access scheme. Various heuristics can be applied to reduce the number of required state elements and memory contents that are saved. Such heuristics may result in the required state elements not trivially those that are reached from the combinatorial fan-in cone of the target signal. Under such an arrangement, the frequency at which snapshots are taken can be higher, such that the low-latency snapshots are taken much closer to a cause state than is possible in the prior art. Further, conditional snapshots (i.e., snapshots that are taken only when specified conditions are satisfied) provide additional performance.

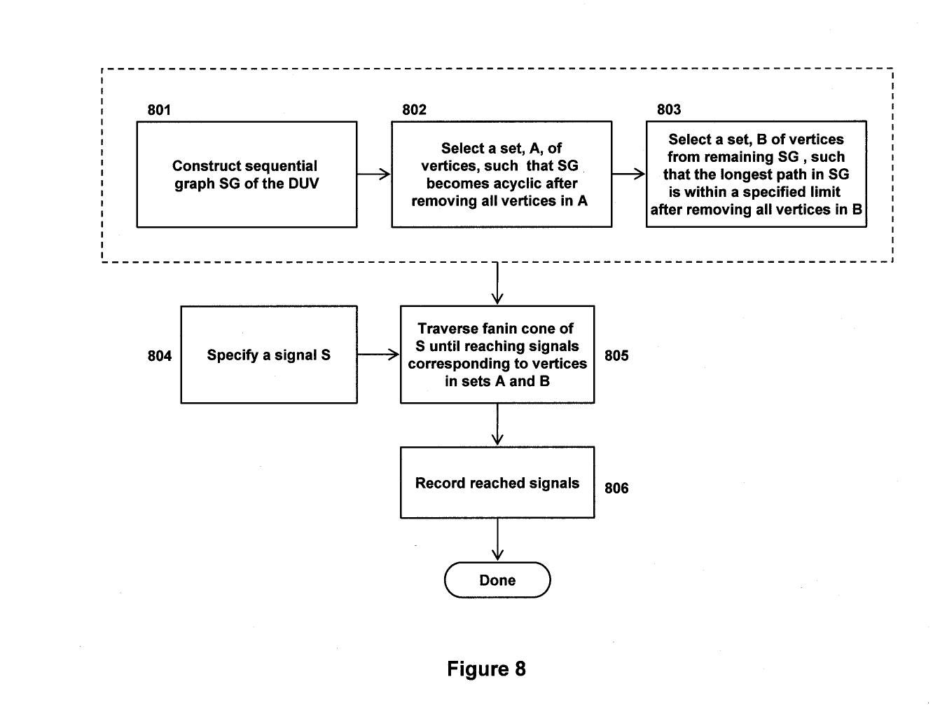

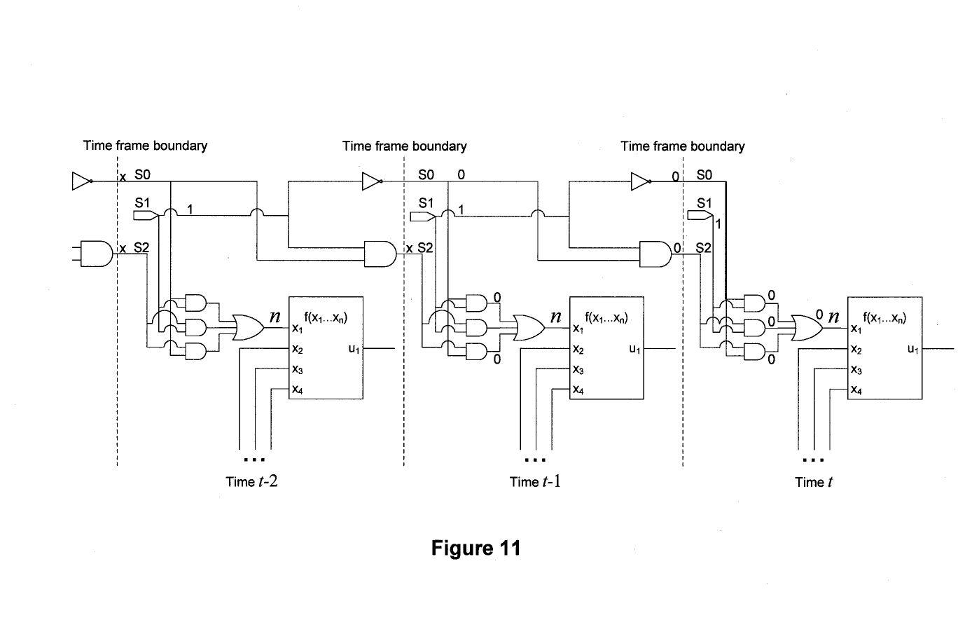

According to one embodiment of the present invention, state elements for a low-latency snapshot are automatically identified from the DUV that is compiled into the prototype. These automatically identified state elements can be used to facilitate debugging and avoid recompilation when other observation points are subsequently requested by the user. FIG. 11 is a flow chart showing the process of identifying state elements for a snapshot automatically, according to one embodiment of the present invention. As shown in FIG. 8, sequential graph SG of the DUV is constructed at step 801. At step 802, set A consisting of vertices of sequential graph SG is identified. The vertices of set A are vertices whose removal from sequential graph SG would result in an acyclic graph (i.e., acyclic graph ASG). At step 803, set B of vertices of acyclic graph ASG is identified. The vertices of set B are the vertices whose removal results in an acyclic graph having a depth for its longest path less than a specified number. Steps 801-803 may be performed “off-line.” At the time of debugging, when a user specifies signal S of the design to be observed (step 804), the fan-in cone of signal S is traversed on the sequential graph SG, terminating at the vertices of set A or set B (steep 805). These vertices correspond to the required state elements for taking snapshots for a subsequent bounded-cycle simulation (step 806). Yet another heuristic generates probe points for I/O signals of certain circuit blocks (e.g., “black box” circuits and analog circuits) and memory elements. As explained above, state elements and memory elements selected for a low-latency snapshots can also be used as automatically generated probes.

In the methods of the present invention, a bounded-cycle simulation technique is used to derive values of signals which are not expressly specified as probe points by the user. The bounded-cycle simulation technique is based on the proposition that: in a sequential graph that has all its sequential loops removed and which has a maximum sequential depth of n, the value of a signal in the sequential graph can be derived from a “complete cut” of the signal's fan-in cone (i.e., values of probes and primary inputs) from the previous n clock cycles.

To remove or cut sequential loops from a sequential graph, a set of vertices of the sequential graph is selected such that when these vertices and the edges going into or coming out of these vertices are removed from the sequential graph, the resulting sequential graph is an acyclic directed graph. According to one embodiment of the present invention, the removed vertices are each replaced by a probe point. To limit sequential depth, a vertex within a path may also be replaced by a probe point.

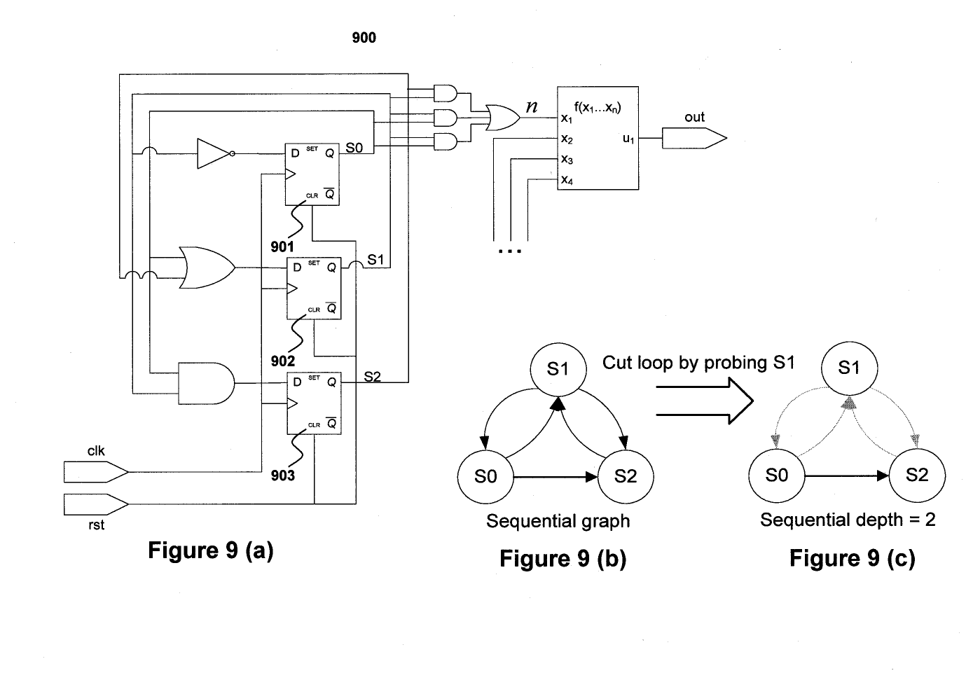

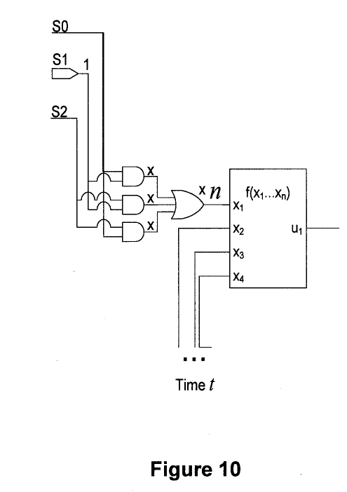

FIGS. 9(a)-9(c) illustrate removing sequential loops in a sequential graph, in accordance with the present invention. As shown in FIG. 9(a), signal n is an internal signal of logic circuit 900 fed by output signals S0, S1 and S2 of sequential elements 901, 902 and 903. Signal S1 is fed back by combinational paths as inputs to sequential elements 901 and 903, and signals S0 and S2 are, likewise, fed back to the input signal of sequential element 902. FIG. 7(b) shows the sequential graph including vertices S0, S1 and S2 extracted from logic circuit 900. FIG. 7(c) shows the acyclic sequential graph resulting from the removal of vertex S1 to result in acyclic sequential graph having a maximum depth of 2. As mentioned above, to perform a bounded-cycle simulation, cutting a sequential loop is achieved by replacing a vertex of the sequential loop by a probe point. FIG. 10 shows the fan-in cone of signal n, with signal S1 replaced by a probe point S1. FIG. 10 also shows that the value of signal n cannot be derived using only the value of probe point S1 at the present time, because the current values of signals S0 and S2 are unknown. However, as illustrated in FIG. 11, values of signal S1 at times t-2, t-1 and t allow the values of signals S1, S2 and n at time t be derived. This process of deriving values of signals using probes and input vectors is referred to as bounded-cycle simulation.

The above detailed description is provided to illustrate the specific embodiments of the present invention and is not intended to be limiting. Numerous variations and modifications within the scope of the present invention are possible. The present invention is set forth in the following claims.

We claim:

1. A method for debugging a logic circuit implemented in a prototype having a fault state observed during emulation, comprising:
selecting a time point prior to the time at which the fault state is observed;
taking a snapshot at the selected time point covering the state elements of the logic circuit;
recording input stimuli and output responses in the prototype during emulation, beginning at the selected time point;
mapping the input and output events to cycles of a reference clock signal; and
debugging using vector emulation, wherein the vector emulation is initialized by the captured snapshot, and the vector emulation is run by applying the recorded input stimuli and comparing the output responses to the recorded responses relative to the cycles of the reference clock signal.

2. A method as in claim 1, wherein the vector emulation comprises generating required probes that are configured into the prototype.

3. A method as in claim 2, wherein the required probes comprise user-specific probes.

4. A method as in claim 2, wherein the required probes comprise automatically generated probes.

5. A method as in claim 4, wherein the automatically generated probes are generated according to a heuristic.

6. A method as in claim 5, wherein the heuristic selects a signal to probe based on a sequential graph representation of the logic circuit.

7. A method as in claim 6, wherein the heuristic selects the signal to probe by identifying state elements which removal removes a sequential loop in the sequential graph.

8. A method as in claim 7, wherein the heuristic selects the signal to probe based on the sequential depth of a path in the sequential graph.

9. A method as in claim 2, wherein the required probes are identified by traversing the fan-in cones of signals giving rise to the fault state.

10. A method as in claim 1, wherein the vector emulation comprises taking snapshots of required state elements of logic circuit.

11. A method as in claim 10, wherein the required state elements are identified by traversing fan-in cones of signals giving rise to the fault state.

12. A method as in claim 10, wherein the required state elements are stored in a random access memory device.

13. A method as in claim 1, wherein mapping the input and output events comprises mapping clock cycles of clock signals associated with the input and output events to clock cycles of the reference signal.

14. A method as in claim 1, wherein the vector emulation comprises running a bounded-cycle simulation to derive values of signals in the logic circuit not specified as probes during configuration of the prototype.

15. A method as in claim 1, wherein running a bounded-cycle simulation comprises constructing a sequential graph representing the logic circuit.

16. A method as in claim 15, wherein the bounded-cycle simulation is performed a portion of the logic circuit represented by an acyclic sequential graph derived from the sequential graph representing the logic circuit.

17. A method as in claim 16, wherein the acyclic sequential graph results at least in part from cutting sequential loop from the sequential graph.

18. A method as in claim 16, wherein the acyclic sequential graph has a maximum depth less than a predetermined maximum.

19. A method as in claim 18, wherein the acyclic sequential graph results at least in part from removing sequential elements from a path in the sequential graph having a maximum depth greater than the predetermined maximum.

20. A method as in claim 15, wherein the bounded-cycle simulation is run on a host processor separate from the prototype.
